(19) United States
(12) Patent Application Publication
(10) Pub. No.: US 2002/0076535 A1
(43) Pub. Date: Jun. 20, 2002

(54) Thermosetting fluorinated dielectrics and multilayer circuit boards

(75) Inventor: Nawalage Florence Cooray, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/892,608

(22) Filed: Jun. 28, 2001

(30) Foreign Application Priority Data
Nov. 1, 2000 (JP) 2000-334547

(51) Int. Cl. B32B 15/08

(52) U.S. Cl. 428/209; 428/458; 528/125

(57) ABSTRACT

A dielectric film is obtained by heat curing a thermally curable fluorinated o-aminophenol polymer or oligomer based on an o-aminophenol compound and an aromatic dicarboxylic acid compound, at least one of which is mono- or poly-fluorinated, and having thermosetting groups at both ends that undergo cross-linking reaction upon thermal treatment. The dielectric film is employed in multilayer circuit boards.

### CROSS-REFERENCE TO RELATED APPLICATION

This application is based upon and claims priority of Japanese Patent Application No. 2000-334547, filed Nov. 1, 2000, the content being incorporated herein by reference.

### BACKGROUND OF THE INVENTION

1. Field of the Invention

The present invention relates to a series of thermosetting fluorinated dielectrics, which are particularly suitable for use as interlayer dielectric in thin film multilayer circuit boards such as multi-chip modules (MCMs) and single chip packages (SCPs).

2. Description of the Related Art

Among the polymeric materials, polyimides have been extensively studied for use in MCMs due to excellent thermal stability, solvent resistance and moderate dielectric constant (3.0) despite their high water uptake and some limitations in thin film metallizations. Recently, some improvements in water uptake and dielectric constant have been obtained in polyimides by introducing fluorine or fluorinated groups in the polyimide backbone.

However, it seems that reduction of polyimide dielectric constant below 2.5 is very difficult, even if a high percentage of fluorine is introduced because of the carboxyl groups in the polymer backbone.

It has been reported that fluorinated polybenzoxazoles (PBOS) exhibit better dielectric properties, dielectric constant <2.5, as compared with fluorinated polyimides. However, introduction of high percentage of fluorine would result some unfavorable properties such as loss of mechanical strength, solvent resistance and increase in coefficient of thermal expansion.

### BRIEF SUMMARY OF THE INVENTION

It is therefore the object of the present invention is to solve these problems of the prior art by providing a material that would give dielectric films with excellent thermal, mechanical and dielectric properties.

As a result of the concerted research directed toward solving the problems, it has been recognized that in the case of fluorinated PBOs, high fluorine contents in the starting monomers result in reduced monomer reactivity, thereby suppressing the molecular weight of the resulting polymers, thus producing films with inferior mechanical properties and poor solvent resistance.

It has then been found that introduction of thermosetting groups at the both ends of the PBO precursor gives a network structure with higher cross-linking density upon thermal curing. This would improve the mechanical properties and solvent resistance of the resulting dielectric.

In other words, the present invention provides a thermally curable fluorinated o-aminophenol polymer or oligomer based on an o-aminophenol compound and an aromatic dicarboxylic acid compound, at least one of which is mono-or poly-fluorinated, and having thermosetting groups at both ends that undergo cross-linking reaction upon thermal treatment.

The invention further provides a dielectric film obtained by heat curing the thermally curable fluorinated o-aminophenol polymer or oligomer.

Furthermore, the invention provides a process for producing a dielectric film comprising heat curing the thermally curable fluorinated o-aminophenol polymer or oligomer.

The invention further provides a multilayer circuit board comprising the dielectric film.

### BRIEF DESCRIPTION OF THE DRAWING

FIG. 1 is a schematic illustration of the fabrication process of a multilayer circuit board using the dielectric material according to the invention.

### DETAILED DESCRIPTION OF THE INVENTION

The thermally curable fluorinated o-aminophenol polymer or oligomer according to the invention may be obtained by reacting an o-aminophenol compound and an aromatic dicarboxylic acid compound, at least one of which is mono-or poly-fluorinated, to produce a fluorinated o-aminophenol polymer or oligomer, and introducing thermosetting reactive groups that undergo cross-linking reaction upon thermal treatment at both ends of the fluorinated o-aminophenol polymer or oligomer. Thus, either one or both of the starting o-aminophenol compound and aromatic dicarboxylic acid compound may contain at least one benzene ring substituted by one or more fluorine atoms or trifluoromethyl groups or at least one moiety with one or more trifluoromethyl groups.

Suitable o-aminophenol compounds may include 1,1,1-trifluoro-2,2-bis(3-amino-4-hydroxyphenyl)propane, 1,1,1,3,3,3-hexafluoro-2,2-bis(3-amino-4-hydroxyphenyl)propane, 2,2-bis(3-amino-4-hydroxyphenyl)propane, bis(3-amino-4-hydroxyphenyl)ether, bis(3-amino-4-hydroxyphenyl)sulfide, bis(3-amino-4-hydroxyphenyl)ketone, bis(3-amino-4-hydroxyphenyl)sulfone and mixtures thereof. Suitable aromatic dicarboxylic acid compounds may include 2,2-bis(4-carboxyphenyl)-1,1,1,3,3,3-hexafluoropropane, 2,2-bis(4-carboxyphenyl)-1,1,1-trifluoromethylpropane, 2,2-bis(4-carboxyphenyl)propane, 2-fluoroisophthalic acid, 4-fluoroisophthalic acid, 5-fluoroisophthalic acid, 3-fluorophthalic acid, 4-fluorophthalic acid, 2-fluoroterephthalic acid, 2,4,5,6-tetrafluoroisophthalic acid, 3,4,5,6-tetrafluorophthalic acid, 2,3,5,6-tetrafluoroterephthalic acid, and compounds represented by the following formulae,

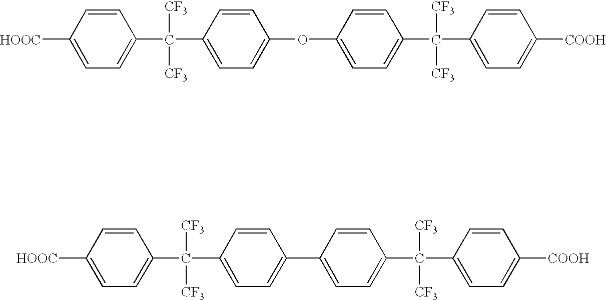

and mixtures thereof. These aromatic dicarboxylic acids may be in a salt form.

Examples of the thermosetting reactive groups which are introduced, as end-capping groups, at both ends of the fluorinated o-aminophenol polymers or oligomers and crosslinks upon heating may include a carboxybenzocyclobutenyl group, a phenylethynyl group, a nadiimide group, a maleimide group, a cyanate ester group and the like.

The thermally curable fluorinated o-aminophenol polymer or oligomer, i.e., the end-capped fluorinated PBO precursor may then be formed into a resin varnish by dissolving it in organic solvents. Preferred organic solvents may include N-methylpyrrolidone (NMP), N-cyclohexylpyrrolidone, N,N-dimethylformamide, N,N-dimethylacetamide, dimethylsulfoxide, 1,3-dimethyl-2-imidazolidinone and the like. The solvents can be used alone or in combination of two or more thereof.

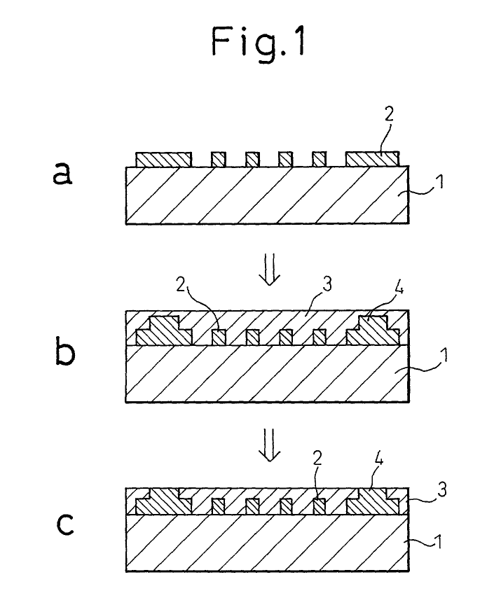

The varnish may be coated onto a substrate by a conventional method that includes screen printing, curtain coating, roll coating and spin coating to form a dielectric film with a desired film thickness. For example, the varnish is spin coated onto an AlN substrate 1 having a Cr/Cu fine wiring pattern 2 with stud vias 3 (a of FIG. 1). The coating is subsequently dried at 100-200° C. for 10-20 minutes. Next, it is heated in nitrogen atmosphere at 150° C. for 1 hour and then at 350° C. for 1 hour to form a fully cured dielectric film 4 (b of FIG. 1). The resulting dielectric film is then subjected to surface planarization by chemical mechanical polishing (CMP) method (c of FIG. 1). This procedure may be repeated to form a multilayer circuit board.

The present invention will further be illustrated by way of the following non-limitative examples.

### EXAMPLE 1

A mixture of 1,1,1,3,3,3-hexafluoro-2,2-bis(3-amino-4-hydroxyphenyl)propane (3.66 g, 0.010 mole) and pyridine (1.7 ml, 0.021 mole) in NMP (20 ml) was placed in a reaction vessel equipped with a magnetic stirrer and a nitrogen purge system, and the mixture was cooled to 5° C. in an ice bath. To this was added 2,2-bis(4-carboxyphenyl)-1,1,1,3,3,3-hexafluoropropane (3.86 g, 0.009 mole) in NMP (5 ml) immediately and the temperature was slowly raised to room temperature and the solution was stirred for 1 hour. Next, benzocyclobutene-2-carboxylic chloride (0.649 g, 0.001 mole) in NMP (2 ml) was added to the mixture and stirred for further 6 hours. The resulting end-capped oligomer was precipitated in a mixture of methanol/H₂O (50 v/v %), washed with methanol/H₂O and dried in a vacuum oven at 120° C. for 6 hours.

Benzocyclobutene-2-carboxylic chloride used above was synthesized from benzocyclobutene-2-carboxylic acid [J. Macromol. Sci. Chem., A28 (11, 12), 1079(1991)] and SOCl₂.

The obtained oligomeric PBO precursor was dissolved in NMP to form a varnish (20-30 wt % polymer). The varnish was coated onto a pre-treated (3% trimethylammonium hydroxide) Si-wafer by spin coating (500 rpm/10 sec and 135 rpm/30 sec) and then prebaked at 100-120° C. in an oven (N₂ ). Finally, hard baking was effected at 200° C. for 30 minutes and at 350° C. for 1 or 2 hours in an inert gas oven. Films (10-20 μm) were removed from the Si-wafers by dipping into a diluted HF solution.

The thermal degradation onset temperature (TGA, 10° C./min in nitrogen), glass transition temperature (TMA, 10° C./min in nitrogen), tensile strength and elongation at break and thermal expansion coefficient of the films were measured.

The varnish was spin coated (500 rpm/10 sec and 1350 rpm/30 sec) onto an AlN substrate having a Cr/Cu fine wiring pattern with stud vias (a of FIG. 1), which was prepared by the following steps: Cr/Cu sputtering on AlN, photo-resist patterning on the Cu seed layer, Cu electroplating, photo-resist patterning (via hole pattern) on Cu pattern, and finally Cu plating (stud via formation). The coating was subsequently dried at 100-120° C. for 10-20 minutes. Next, it was heated in nitrogen atmosphere at 150° C. for 1 hour and then at 350° C. for 1 hour to form a fully cured dielectric film (b of FIG. 1). The dielectric film was then subjected to CMP method (c of FIG. 1). This procedure was repeated to form a multilayer circuit board.

### EXAMPLE 2

A mixture of 1,1,1,3,3,3-hexafluoro-2,2-bis(3-amino-4-hydroxyphenyl)propane (3.66 g, 0.010 mole) and pyridine (1.7 ml, 0.021 mole) in NMP (20 ml) was placed in a reaction vessel equipped with a magnetic stirrer and a nitrogen purge system, and the mixture was cooled to 5° C. in an ice bath. To this was added 2,2-bis(4-carboxyphenyl)-1,1,1,3,3,3-hexafluoropropane (3.86 g, 0.009 mole) in NMP (5 ml) immediately and the temperature was slowly raised to room temperature and the solution was stirred for 1 hour. Next, 4-phenylethynylbenzoyl chloride (0.24 g, 0.001 mole) in NMP (2 ml) was added to the mixture and stirred for further 6 hours. The resulting end-capped oligomer was precipitated in a mixture of methanol/H₂O (50 v/v %), washed with methanol/H₂O and dried in a vacuum oven at 120° C. for 6 hours.

4-phenylethynylbenzoyl chloride used above was synthesized from 4-phenylethynylbenzoyl acid (Manac Corporation) and SOCl₂.

The rest of the procedures was conducted as in Example 1.

### COMPARATIVE EXAMPLE

A mixture of 1,1,1,3,3,3-hexafluoro-2,2-bis(3-amino-4-hydroxyphenyl)propane (3.66 g, 0.010 mole) and pyridine (1.7 ml, 0.021 mole) in NMP (20 ml) was placed in a reaction vessel equipped with a magnetic stirrer and a nitrogen purge system, and the mixture was cooled to 5° C. in an ice bath. To this was added 2,2-bis(4-carboxyphenyl)-1,1,1,3,3,3-hexafluoropropane (4.29 g, 0.010 mole) in NMP (5 ml) immediately and the temperature was slowly raised to room temperature and the solution was stirred for 6 hours. The product was precipitated in a mixture of methanol/H₂O (50 v/v %), washed with methanol/H₂O and dried in a vacuum oven at 120° C. for 6 hours.

Physical property measurements of the resulting polymer were conducted as in Example 1.

Physical properties of the dielectric materials obtained in Examples 1 and 2 and Comparative Example are given in Table below.

TABLE

| | | | Comparative |
|---|---|---|---|
| Physical property | Example 1 | Example 2 | Example |
| Decomposition onset | 410 | 420 | 460 |
| tem. (° C.) | | | |
| Glass Transition tem. | 360 | 350 | 310 |
| (° C.) | | | |
| Tensile strength (MPa) | 130 | 150 | 80 |
| Elongation at break | >8 | >6 | >10 |
| Peel strength (kgf/cm) | 0.80 | 0.80 | 0.70 |
| Dielectric constant | 2.40 | 2.50 | 2.45 |
| (1 MHz) | | | |
| Dielectric loss (1 MHz) | 0.005 | 0.004 | 0.005 |
| Thermal expansion | 40 | 45 | 55 |
| coefficient (ppm) | | | |

According to the present invention it is possible to obtain dielectric materials with excellent thermal, dielectric and mechanical properties and solvent resistance.

What is claimed is:

1. A thermally curable fluorinated o-aminophenol polymer or oligomer based on an o-aminophenol compound and an aromatic dicarboxylic acid compound, at least one of which is mono- or poly-fluorinated, and having thermosetting groups at both ends that undergo cross-linking reaction upon thermal treatment.

2. A thermally curable fluorinated o-aminophenol polymer or oligomer according to claim 1, wherein either one or both of the o-aminophenol compound and aromatic dicarboxylic acid compound contain at least one benzene ring substituted by one or more fluorine atoms or trifluoromethyl groups or at least one moiety with one or more trifluoromethyl groups.

3. A dielectric film obtained by heat curing a thermally curable fluorinated o-aminophenol polymer or oligomer according to claim 1 or 2.

4. A process for producing a dielectric film comprising heat curing a thermally curable fluorinated o-aminophenol polymer or oligomer according to claim 1 or 2.

5. A multilayer circuit board comprising a dielectric film according to claim 3.
